(19) United States
(12) Patent Application Publication
(10) Pub. No.: US 2004/0060035 A1
(43) Pub. Date: Mar. 25, 2004

(54) Automated method and system for building, deploying and installing software resources across multiple computer systems

(76) Inventor: Eric Ustaris, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/253,082

(22) Filed: Sep. 24, 2002

(51) Int. Cl. G06F 9/44; G06F 9/445

(52) U.S. Cl. 717/100; 717/120; 717/174

(57) ABSTRACT

A method and system for automatically and remotely performing a resource upgrade on a computer system coupled to a central distribution source are disclosed. An install package designated for the destination computer system is deployed from the central distribution source. The install packaged is copied on the computer system and copies an install program associated with the install package on the same machine. Lastly, a resource program upgrade is installed on the computer system using the install program and contents within the install package.

### BACKGROUND OF THE INVENTION

1. Field of the Invention

The present invention relates generally to providing software resources or upgrades across a computer network to interested computer systems.

2. Related Art

The computer industry has evolved tremendously over the years from its infancy. The computer industry has transitioned from a terminal emulation system where users utilized dumb terminals that were connected to a mainframe that was readily maintained by a core of computer technicians to upgrade the software and other resources at the mainframe source as well as at the terminal levels. Next, workstations became popular that operated on their own operating systems and generally were not interconnected. Upgrading these systems was slow and expensive in that each system had to be maintained individually.

Following the independent workstations, the technology shifted from mainframe central processing systems to central processing unit communications to Windows workstations with proprietary software loaded on the end client's machines. These systems also had to be maintained individually with appropriate software patches and upgrades as well as resource additions that required either contracted out information technology specialists or dedicated in-house IT professionals. Many of these systems remain today and are expensive to maintain and support.

These existing computer systems also incur high operating costs. Since each system has to be maintained individually, they also have high maintenance costs because maintenance requires site visits by IT professionals. Support costs are also high for software installed on customer sites, especially when there must be support for numerous customer operating environments/local area networks (LANs). Software updates often require the dispatch of such IT professionals to each customer site for installation of the new or updated program. Otherwise, the business or end user must be computer literate in installing the new or upgraded resource and must be ever vigilant in looking for new fixes or upgrades that would make the system operate more efficiently or fix inadvertent problems.

Further, many businesses have multiple systems in their offices and each system is specifically focused on managing different types of products. Platforms that are capable of integrating across products are rare at best. There are also problems with existing computer systems because they require extensive time to market. Time to market, meaning the time it takes to develop or upgrade a program and test it before shipping it for sale, is significant in that the shorter the time, the quicker new products can be implemented and the benefits obtained by the end users.

One solution has been to provide software distribution programs that are able to receive software updates, forward them to interested locations, such as a computer that can communicate with a central provider, server or host, so that the software may be distributed to the system and then installed thereon. Typically these software distribution programs are dedicated to one platform type, such as Unix, Windows or Linux, just to name a few. Further, the software distributors typically operate in a proprietary packaging format that may become orphaned or obsolete in a short time and no longer supported.

Moreover, the prior art systems are unable to perform an auto deploy sequence in that a specific request must be made by the destination machine so that the host providing the upgrade can then forward the software upgrade for installation. Next, the user, or someone capable of installing the upgrade, so that the installation may actually be implemented, must access the destination machine. Thus, no automatic installation process exists in the prior art of software distribution programs. Further, these software distribution programs are limited in that they are intended to operate on a common intranet system and need not pierce through any network firewalls typically set up to prevent unwanted and undesirable intrusions by software and system hackers or bug programs.

### SUMMARY OF THE INVENTION

According to the present invention, a method and system for building a software package composed of a plurality of software components that are generated by a plurality of software developers are disclosed. The method begins by submitting the software components for inclusion within the software package by means of modifying a build manifest. Next, the system initiates a building of the software package based on the manifest. The software build is performed based on the plurality of software components. Next, the method verifies that the build of the software package is successful by installing the package on at least one destination quality assurance machine for verification. The invention further includes a method and system for automatically performing a resource upgrade on a computer system coupled to a central distribution source. This method deploys an install package designated for the destination computer system from the central distribution source. The method then copies the install package on the computer system and copies an install program associated with the install package on the same machine. Lastly, this method installs the software components on the computer system using the install program and contents within the install package.

### BRIEF DESCRIPTION OF THE DRAWINGS

FIG. 1 is a schematic view of an auto-build and auto-deploy system in accordance with an embodiment of the present invention;

FIG. 2 is a schematic view of the auto-build system embodied in the invention and as described in FIG. 1;

FIG. 3 is a flow diagram of a build operation as implemented by the auto-build system embodied in FIG. 2;

FIG. 4 is a schematic diagram of the auto-deploy system as embodied in FIG. 1;

FIG. 5 depicts a flow diagram of an implementation an embodiment of the auto-deploy utilized to install a software package on a target machine; and

FIG. 6 is a flow diagram of a sample auto deploy and install operation as implemented according to one embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention overcomes the problems of the prior art by providing an automated build system and method for automatically building a software application based upon submissions from the software programmers. The system further includes an automated deployment and installation system and method for taking a revised or updated software product and deploying it to interested users on their computer system and having it install it automatically in a transparent manner. The system and method are able to deploy and install the software products on different computer platforms.

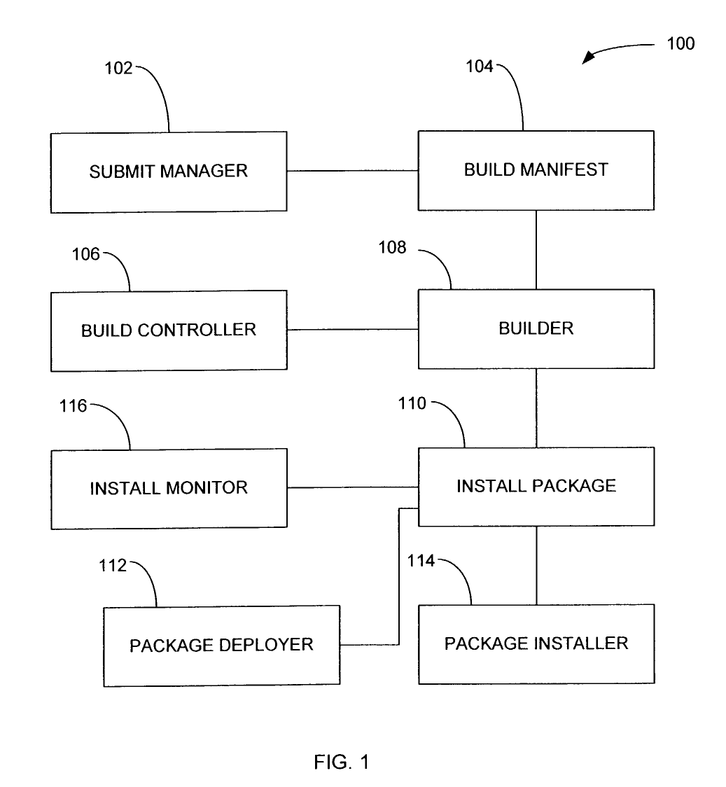

FIG. 1 illustrates a first portion of the program in accordance with the invention in that it describes and illustrates the automated build system 100 that is able to provide computer program build cycles performed automatically in a 24 hour a day 7 days a week timeframe. The system further includes an auto deployment and auto installation feature of an install package that enables the package to be sent to a specified list of destination computers or machines as previously mentioned.

The system 100 includes a submit manager 102, which manages all of the build manifests for each software build routine. It also provides an interface for the user, i.e. the individual responsible for the building of the software package, to view and edit each build manifest. System 100 then maintains a build manifest 104, which contains the list of packages to include in a particular build, wherein each package includes applications or services. System 100 includes build controller 106, which is responsible for invoking the builder operation, also known as builder 108, to perform a particular software or package build. Build controller 106 has several modes of operation.

The modes of operation associated with the build controller 106 include an automatic mode of build, a scheduled mode of build, a blackout mode of build, and a manual override mode of build, any of which may be selected at any time. The automatic mode of build directs the controller 106 to detect automatically when a build manifest 104 has been modified and then directs the controller 106 to invoke automatically a builder 108 to perform a build using the modified build manifest 104. The scheduled mode build directs controller 106 to use its internal scheduler to wake up at predetermined times to determine if a build manifest 104 has been modified and consequently invoke a builder 108, if appropriate. The blackout mode build directs the build controller 106 to detect automatically when a build manifest 104 has been modified, but also directs controller 106 to check its internal scheduler to insure that the current time does not fall within a configured blackout period before invoking a builder 108. These blackout periods are provided to increase engineer productivity by ensuring that the system will be available within specific time intervals throughout the day. Lastly, the manual override mode build directs build controller 106 to detect automatically when a build manifest has been modified and then directs the controller to invoke automatically a builder 108 to perform a build, ignoring all entries that may exist in its internal scheduler. It should be noted that multiple build manifests 104 can exist simultaneously.

Build controller 106 is capable of operating in one of the modes described above for each manifest and is also able to invoke concurrently a builder 108 for each manifest. Builder 108 is responsible and utilized for creating an install package 110, based upon a specific build manifest 104.

Install package 110 functions as a virtual container built via common and standard tools well known to those skilled in the art. Install package 110 can be delivered to and unpacked on multiple computer platforms and includes a list of packages specified by the appropriate build manifest 104.

A package deployer 112 is provided and is responsible for delivering an install package from a source machine to a destination machine. Package deployer 112 is also able to deliver packages to destinations on multiple computer platforms.

A package installer 114 is also provided within install package 110. Package installer 114 is responsible for installing the contents of an install package 110 onto a destination machine or computer. Install controller 408 can operate in an automatic mode and a manual mode. The automatic mode instructs the install controller 408 to detect automatically when a new install package has been delivered to the local machine and to install automatically the contents of the install package. The manual mode instructs the controller to ignore new packages delivered to the local machine because they will be manually installed. Package installer 114 stops or shuts down any existing applications prior to installation of the new or updated packages on the machine and then restarts all the package applications after the installation is complete so that the update appears transparent to the end user after the installation has been performed. An install monitor 116 is also provided and serves to report which install packages have been installed on each destination computer. The monitor also is capable of interacting with computers on multiple platforms.

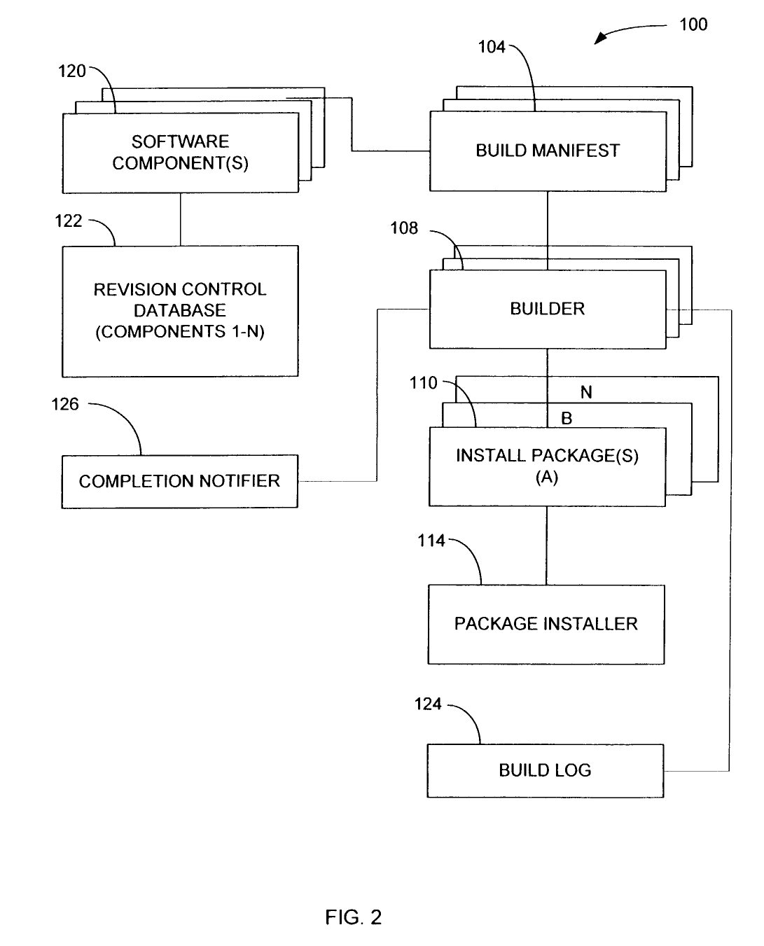

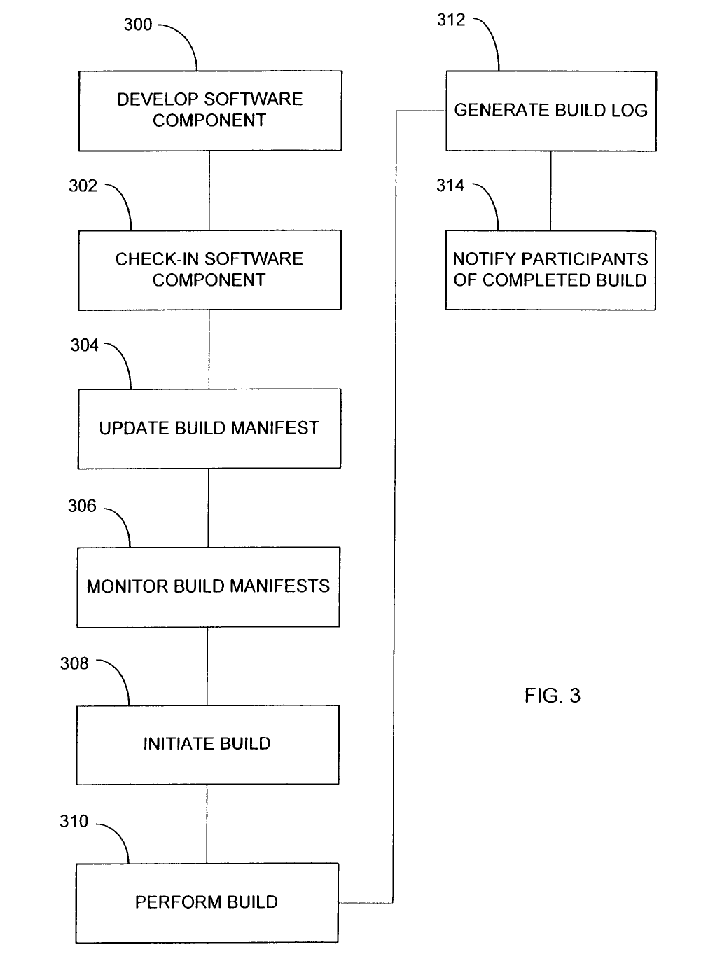

The build process is described in greater detail below and as illustrated in FIG. 2 accompanied by the flow diagram of FIG. 3.

The development process for developing a software component or upgrade of a software program begins with each engineer generating his or her own particular software component within a self-contained environment in which their development work is performed. The self-contained environment is within a computer that allows the engineers to develop, compile, and test code independently from other software engineers or programmers. Multiple self-contained environments can exist on the same computer. The system provides a program that allows each engineer to create or delete his or her own self-contained environments as necessary.

The goal of the software programmer or engineer is to create functioning code based upon a set of requirements from the customer. All of the code written by the engineer is what is loosely referred to as a software component 120. Thus, in block 300 of FIG. 3, the first step is to develop a software component 120. Next, in block 302, one or more completed software components 120 are checked in for processing and integration within the overall software program. The development process continues until the engineer is satisfied with the software component in that it performs as expected without any problems or bugs. The software component check-in procedure involves depositing a copy of the software component 120 into a revision control system or revision control database 122 for safekeeping. When a software component 120 is extracted or an item is extracted from the revision control system or database 122, this is known as item checkout. Various types of revision control system products are available. The build process currently utilizes a revision control system known as “Concurrent Versions System” (CVS) which is available as an open-source standard product.

Revision control systems are utilized to store items for safe keeping and provide a centralized or control database 122 among the many development engineers so that they can view and access all items in the revision control system. Thus, over time, an engineer may make a number of modifications to a software component 120 as it evolves and store many copies of the software component in the revision control system. The revision control system serves to keep track of all of the software components and all of the different versions of each software component such that a copy of any one of those items can be obtained at any time. Further, the revision control system also maintains copies of previously run program or product builds so that when errors occur, the last safe state may be retrieved so that the build can be done again with corrected software components.

Up until this point, the engineer has seen the behavior of the software component that he or she has been building only within the context of its own self-contained environment. The engineer has not seen how the component behaves in an environment containing other software components. Thus, the engineer is not certain whether the software components will have an affect on his or her software component or vise versa. Accordingly, the build process then assembles a specified list of software components into a single installation package 110. The list of software components 120 is what is referred to as a build manifest 104, which is generated in block 304. Although the revision control system can contain hundreds of software components 120, each build manifest 104 typically refers only to a small subset of software components in the revision control system. There need not be just one build manifest 104, but a plurality of build manifests 104 can exist at the same time with the build process. For example, a build manifest 104 exists for each customer that has requested an install package 110 and the build manifest 104 is utilized to generate the install package for that customer.

Next, the build process continues as the build controller 106, which constantly monitors all of the build manifests, detects that a build manifest 104 has been modified and begins a build process to handle the particular build manifest 104. The process then performs the monitoring of the build manifest as shown in block 306. If there are multiple build manifests that have been modified, the build controller 106 starts a build process to handle each build manifest 104 that has been modified. This may occur simultaneous or consecutively and the execution of this processed can be performed at any time.

Next, as shown in block 308, the process begins to initiate the build via builder 108. As previously stated, there are four types of modes of build. There is the on demand mode, periodic schedule mode, the one time schedule mode, and the schedule override mode.

In the on-demand mode, the build controller frequently checks to see if any build manifests have been modified. Upon detecting that a manifest has been modified, a build is immediately initiated to handle the modified manifest.

In the periodic schedule mode, the build controller frequently checks its scheduler to determine if it is time to perform a build. It will only initiate a build if a build manifest has been modified. Note that in this mode, any number of changes can be made to the build manifest. All changes are accumulated until a build is initiated. An example use of this mode is scheduling a build to occur for a particular build manifest every Monday morning at 8:00 am.

The one-time schedule mode is similar to the “periodic schedule” mode except that the scheduled build is performed one-time only at the designated date and time.

In the schedule override mode, the user can explicitly cause a build to be initiated by selecting the option to do so. The user is aware that a build has been scheduled to occur, but chooses instead to override the schedule.

Any number of build modes can be used at any time for a different build manifest or manifests. For example, if there are three build manifests labeled A, B and C that are currently active, manifest A may be configured to use the on-demand build mode, while manifest B may be configured to use the periodic schedule mode, and manifest C may be configured to use the one-time schedule mode.

Once the initiation of the build has been requested, the process, through builder 108, actually performs the build as depicted in block 310. To perform the build operation, the process obtains the list of software components 120 from the build manifest 104 to be included in the build. Next, the process then extracts a copy of each software component as specified in the particular build manifest from the revision control system or database. Next, the process generates an install package 110 containing the software components specified in the build manifest. Thus, more than one install package 110 can be generated and is represented by install packages A-N. The install package 110 is created as a “jar” file, which is similar to a “zip” file in that it is a single file that contains other files and directories therein. A separate installation instructions document is also produced detailing exactly how to install the newly created software package. The process also provides the ability to perform real time monitoring of each build process that is executing. Thus, at any given time, anyone can view the number of steps that have been performed by a particular build process and view the number of pending steps to be performed. Each install package further includes a package installer 114.

After the build process has been completed, the process creates a build log 124 as depicted in block 312. Each build process creates its own build log 124 or audit trail of its activities. Thus, if any errors are encountered during the build, or if there are any questions related to that particular build, the build log 124 can be referenced. Upon completion, notification is forwarded to all interested parties as depicted in block 314 via completion notifier 126. Typically, the notification is provided via email to a build distribution list that the build has completed. Those engineers that have submitted software components for that particular build operation are notified, as is the software development manager who oversees the actual build of each software product or revision. The build product also includes an interface means, such as an intranet or internet connection, that allows users to subscribe or unsubscribe to the build distribution list. Those that are subscribed to the list will receive notice that the build has been completed while those that have unsubscribed will no longer be listed to receive such notice.

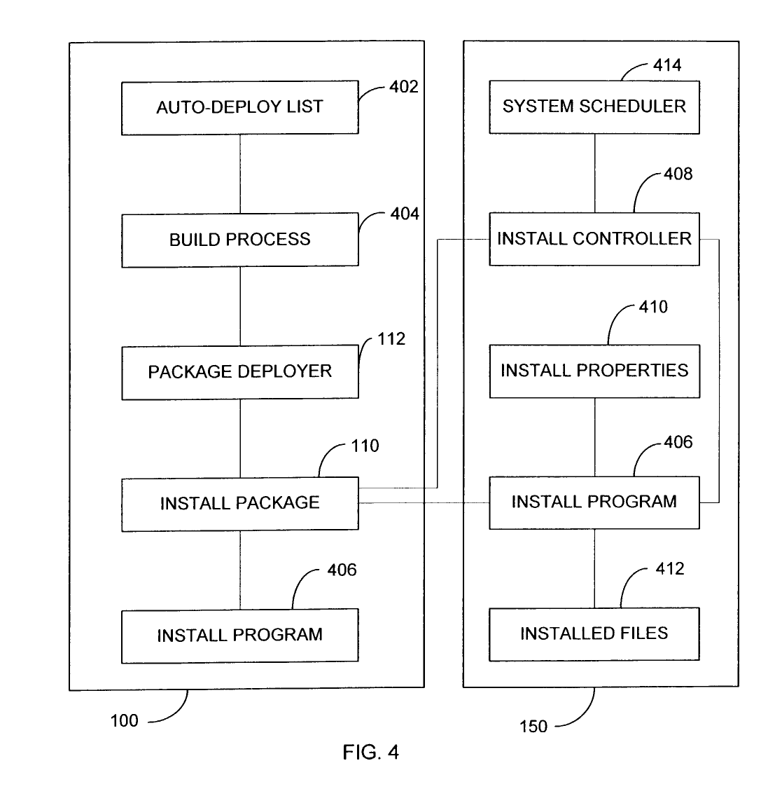

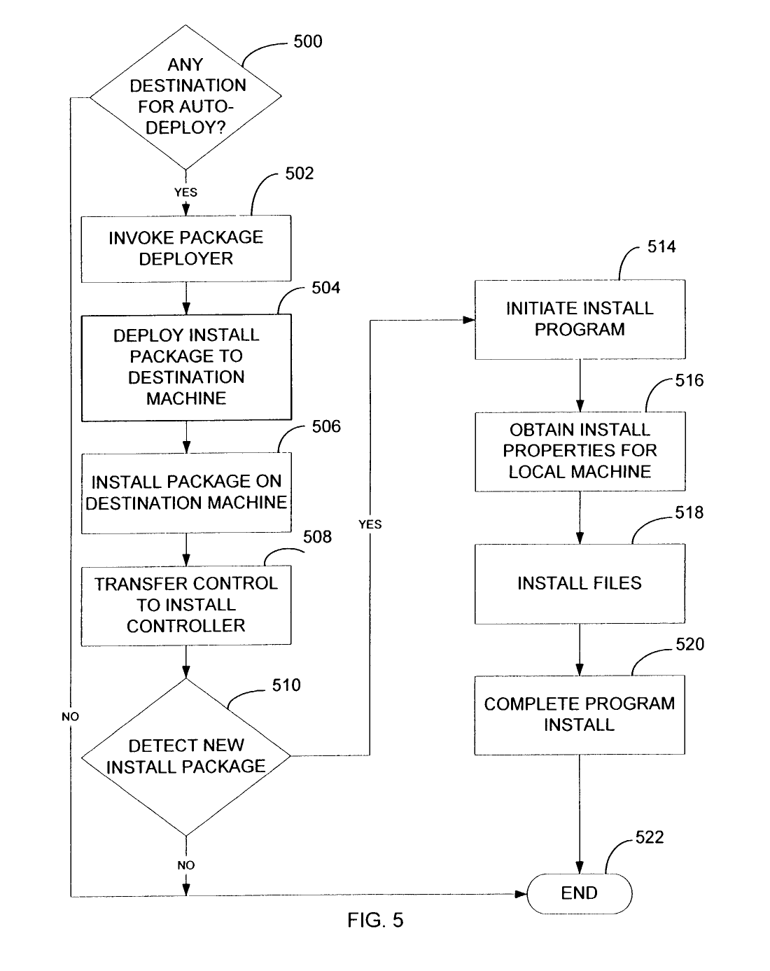

Once the build process has been completed, then the system can proceed with the automated software revision deployment and installation process, which is illustrated in greater detail in FIG. 4 and described in the accompanying flow diagram of FIG. 5.

Initially, the system 100 determines whether there are any auto deploy configurations found on an auto-deploy list 402, which is actually done by each build process 404. Thus, as shown in block 500, each build process 404 determines if any auto deploy destination machines 150 have been configured for the current build manifest. If not, then the build process ends as shown in Block 522; otherwise, the build process automatically invokes the package deployer 112 for each machine 150 configured in the auto-deploy list as illustrated in block 502.

The package deployer 112 is also responsible for copying an install package 110 to a destination machine 150, as shown in block 504. Each install package 110 also includes a separate install program 406 that is always copied with the install package as shown in block 506. The install program 406 knows how to install its associated install package 110, but does not necessarily know how to install other install packages.

To copy the install package 110 and install program 406 to a destination machine 150, the package deployer 112 utilizes a common utility program called “file transfer protocol” (ftp). This utility program is found in most operating systems such as Windows, Unix, Linux, and others, which enables files to be copied to machines of different platforms. An enhanced version of ftp is called socksified ftp, which allows files to be copied to destinations inside and outside of a network firewall.

It is possible to invoke the package deployer 112 manually. This allows customers the option to maintain complete control over their machines, which includes disabling the auto deploy mechanism for their system. They always manually invoke the package deployer per their own discretion.

The system 100 then transfers control to the install controller 408, which is shown in block 508. The install controller determines if any install packages 110 have been copied onto the local machine 150. The controller 408 is utilized in conjunction with the local system scheduler 414 on that system. For example, in UNIX systems, the scheduling utility called “cron” is utilized. On Windows system, the Task Scheduler is utilized. In all cases on each machine, the scheduler 414 is configured to invoke the install controller 408 on a frequent basis, typically once every minute. Further, the install controller 408 may be optional, and when the user elects not to utilize the install controller, then the user takes control of installing the program.

When the install controller 408 is invoked, it determines in block 510 if one or more install packages 110 have been copied onto the local machine. If an install package has been installed on the local machine, the install controller 408 then initiates the install program to process the install package 110, as shown in block 514; otherwise, the install controller 408 exits to block 522.

When the install program 406 starts up, it first obtains the install values or properties 410 specific to the local or destination machine 150, as shown in block 516. For example, one of the values specifies where to install the actual files, such as “c:\mydir” or “d:\myapps.” Another value indicates where all log files should be located, typically another folder found on the system. The install properties 410 found on the local system or machine 150 allow the install program 406 to be written very generically while providing the most flexibility for the user. Further, this allows the end user or recipient of the upgrade to have greater control over the actual installation to be performed on his or her machine.

After obtaining the install property values 410, the install program 406 then stops any existing relevant server processes that may be executing on that particular system. This is done in a manner that does not interfere with the system and certainly is intended to wait until current processes are done being processed. This is also done to ensure that no related programs or data files are accessed during the remainder of the install process as these files will most likely be overwritten with new files during the install process.

Next, as shown in block 518, once the server processes have been stopped, the install program 406 unpacks the contents of the install package 110 and installs the contents to an installed files location 412 specified in the install properties 410. After the files have been installed, and as shown in block 520, the install program 406 performs any customizations necessary for the current installation. The install process provides a mechanism whereby each service package included in the build can also deliver any number of customization programs that will be executed by the install program. For example, the many files that are to be installed might include an HTML file called “hello.html” containing the line:

This file has been installed on the computer “<COMPUTER_NAME_GOES_HERE>.”

If the current computer name happens to be “Hal,” then one of the customization programs will change the line to read:

This file has been installed on the computer “Hal.”

Although this is a simple example, this feature is utilized extensively by each of the services that are included with each build. This mechanism enables a single install package to be installed on different machines, but gives the impression that a different install package has been created for each machine.

After the new files have been customized, the process proceeds to block 522 where the install program automatically starts up the server processes that were shut down to preserve operations of the software on the machine at the time the install was to be performed. This results in a nearly transparent installation of the program upgrade since the machine is running the same programs both before and after the installation and but for the minor time disruption, no apparent disruption has been caused.

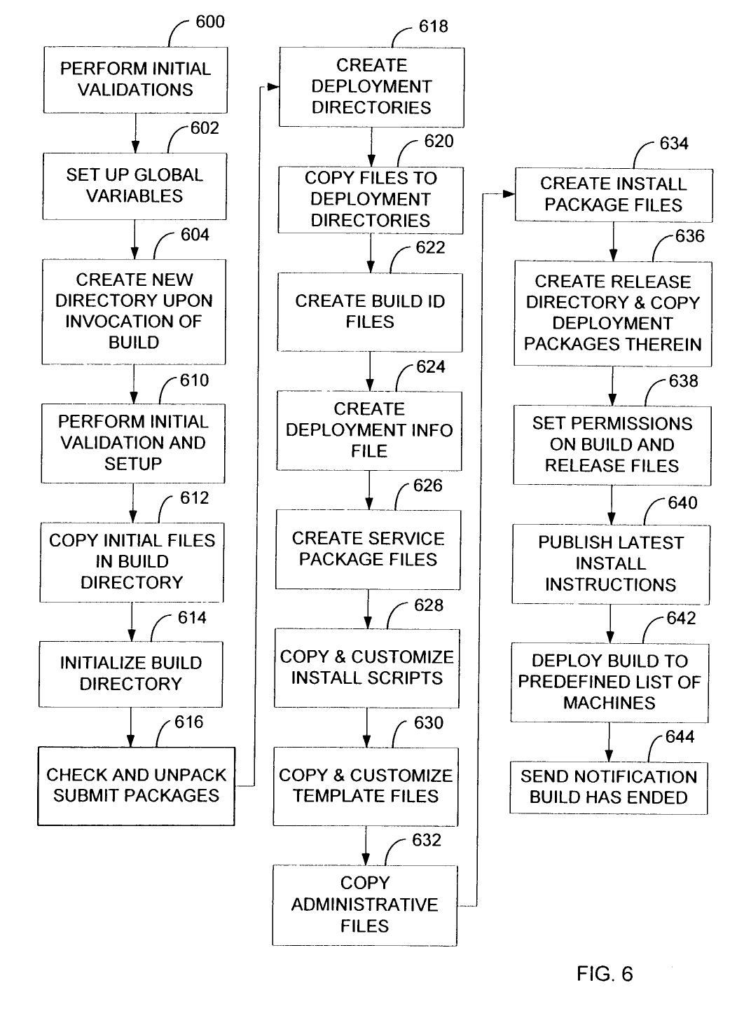

The build process typically follows a build script, which performs the actual assembly of the software package. The example is also illustrated in the flow diagram of FIG. 6. Initially, as shown in block 600, the build process performs a validation of input parameters specified. This is done to ensure that both a build ID and a build type are specified. Next, as shown in block 602, the process sets up global variables, some of which are derived from input parameters. The first argument specified to the build script is the unique build ID, which is a string value used to label the software package being created. The second argument specified to the build script defines the build type via a string value indicating whether the build is a full or partial build. The third argument is optional and specifies to the build script at which build step number the build process starts. This feature allows the build process to be restarted or continued in the event an error was encountered in a particular step. The build process can be restarted from any previous step that was successfully completed by the build process. The fourth argument is also optional and defines the build step number at which the build process stops after executing.

The build process typically has a home directory and each time a build is invoked, a new directory is created, as shown in block 604, using the build ID as the name of the directory. The build is performed in the new directory. After completion of the build, the contents of the directory are left intact. Alternatively, the contents that are no longer necessary may be removed to free up storage space on the system. The remainder of the step defines other miscellaneous variables, such as, for example the location of the auto-deploy program to invoke after the build process completes. The build script also creates the install instructions document specifically for the software package being created.

The build script then performs an initial validation and setup operation as shown in block 610. The initial validations and setup ensure that the build step number file exists, extracts the step number from the step number file denoting which step the build process was on when it ended or terminated, ensures that the step number specified is not greater than the step number the build process was previously executing, deletes the release directory if it exists because it is then out of synch with this build directory if any steps are performed, and lastly resets the build status file that reports all of the steps that have been performed along with the current step being performed.

After initial validation and setup has been completed, the process copies the initial files to build directory as shown in block 612. At this time, the process performs several operations. The first is to copy the build properties file to the build directory. The build properties file contains meta information used by the build process. A build submit manifest is then copied to the directory and it contains the list of submittal packages for all of the services. Next, the system copies and customizes the installation instructions document to the build directory. Lastly, the system copies the script to deploy the install packages created by the build process.

Once the initial files have been copied to the build directory, the process then initializes the build directory as shown in block 614. This is performed by creating the primary directory trees in the build directory. Next, the system, as shown in block 616, checks out and unpacks the submit packages. The entries in the submit package list resemble the following:

ssa#lib#active#_build-lib#HEAD#john_smith#20010513_{—}101110#

x_s#sample#active#_build-sample#sample_{—}1_{—}5#mary_adams#20010516_{—}210414#

x_s#ssa_files#active#_build-ssa_files#HEAD#david_franklin#20010520_{—}010033#

From this package list, the system extracts the CVS project name, service name, and CVS tag value. Afterwards, the system checks out the project files. Next, the system creates the deployment directories, as shown in block 618.

Next, the system copies the files to the deployment directories as shown in block 620. Further, the system then finds the “deploy files” config file for each service. Afterwards, the system then processes each entry in the config file. The “deploy files” config file contains information describing which install package the files should be included. The physical deployment architecture for the software packages includes multiple computer types. For example, some of the computers are designated the responsibility of receiving transaction requests and formatting responses. These computers are referred to as the “frontend” computers. The other computers are designated the responsibility of executing the business logic for each transaction. These computers are referred to as the “backend” computers. Different types of software install packages can be created for installation on the different computer types.

The system creates a “build ID” file(s) in the deployment directories as shown in block 622. These files are actually one file with the same name copied to the different deployment directories. The file name utilizes the format “.build_id” and contains no data. It is included with the install package, or jar file, for each deployment directory so that each install package can be easily and uniquely identified, even if the install package is renamed.

Afterwards, the system then creates a new deployment info file in the deployment directories as shown in block 624. To perform this, the system creates a file containing information that will be utilized by the deploy/install process. This file is utilized as a signal for a process executing in the background to install the newly deployed software package on the destination machine automatically.

The system then proceeds to block 626 where it creates the different types of frontend and backend service package files. Then, the system creates a package file for the frontend deployment directory and the backend deployment directory. Next, the system copies and customizes the install scripts as necessary as shown in block 628. This is done by copying and customizing the install script files for the frontend and backend install script files.

At this time then the system proceeds to copy and customize the server frontend template files and the backend template files, as shown in block 630. Template files are generic files that are installed on each computer but are then customized for each computer by the install process. For each of these template files, the system copies the template files to the appropriate directory. The system then proceeds to copy the administration or admin files as shown in block 632 by copying the admin files for the frontend and backend files.

In block 634, the process then creates frontend and backend install package files. This is done by creating an install package for the frontend installation and a separate install package for the backend installation.

Afterwards, the system proceeds to block 636 where the process creates the release directory and copies the deployment packages into the release directory. The release directory is deleted, if it already exists. Additional information is then copied into this directory that includes the “deploy packages” script, the frontend deployment files, and the backend deployment files. Afterwards, the process then sets permissions on directories and files in the release directory so that the directory and files cannot be accidentally deleted by other users on the computer. Setting permissions on a Unix computer is equivalent to setting the attributes of a file on a Windows computer.

The system then proceeds to block 638 where it then sets permissions on the build and release files.

Next, the process then publishes the latest install instructions as shown in block 640. Publishing the newly created install instructions document causes the document to become visible via the Web site showing the builds which have been completed. Each build includes its own copy of the installation instructions.

The system then automatically deploys the build to a predefined list of machines as shown in block 642. This deployment is performed by checking the contents of a control file to determine whether or not it is permissible to perform the auto-deploy of the new build package to a pre-configured set of destination machines. If the file indicates that it is permissible to perform the auto-deploy, then such will be performed. Otherwise, if the control file is not present, the system will not auto-deploy.

After the auto-deploy functionality has been completed, the system sends an email that the build has ended as shown in block 644. Notice is sent to those parties that are interested in the completion of this build process and auto-deployment via an email distribution list. The system creates an email file that is utilized to hold the text to be emailed. The system writes a mail header to the email file and then checks if this was a special build. The system can also include the reference or hyperlink to the manual install instructions in the email file, if desired. The system can also include a list of machines that the software upgrade has been auto-deployed to in the email file. The system finds the entries that were deleted from the current submit list. The system obtains the list of packages submitted to the build and includes that list to the email file and also shows new or modified packages since the previous build. The system can also include miscellaneous build statistics and unsubscribe information in the email file. When the emails are sent, the system appends a copy of the email message to the audit trail which is used to track the history of builds performed for each build manifest. Each build manifest has its own audit trail. Thus completes a sample operation of the build process in accordance with the present invention.

The present invention provides a software management program that yields a completely automated end-to-end process. This end-to-end process includes the actual build of the software upgrade and then its deployment to those destinations that require or desire such an upgrade upon completion. This build and install end to end process can be evoked on demand at any time and does not need human intervention. Further, the process can provide built-in scheduling features that allow for additional control when builds are initiated. Additionally, the system provides prompt notification for the completion of each build. This automated end-to-end process works with computers on different platforms, such as HPUX, Windows NT, Windows 2000, and Linux. Since less human resources are needed to operate, the auto-build, deploy and install process reduces time and cost in the actual build process as well as reduces the downtime between build cycles as a build cycle can be implemented at any time where as in the past such build cycles typically were scheduled, often on a once a day, once a week, or once a month basis.

The auto-build process thereby eliminates unproductive, idle time waiting for build cycles to be manually initiated by a person. Additionally, it eliminates the need to reimplement redundant solutions to work on different computer platforms since it is compatible with different platforms. Further still, it eliminates the dependency on proprietary packaging formats as was required in the prior art.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method of building a software program composed of a plurality of software components generated by a plurality of software developers, comprising:
automatically building a manifest based on software components submitted for inclusion in the software program;
automatically initiating building of the software program based on the manifest without human input;
automatically performing the build of the software program with the plurality of software components;
independently verifying that the build of the software program is successful; and
independently preparing an installation package for at least one destination machine utilizing the verified software program build.

2. The method according to claim 1 further comprising the step of monitoring the build manifest to determine when the manifest has been modified with a submitted software component to be included in the software program and repeating the initiating, performing and preparing steps as needed.

3. The method according to claim 1 further comprising the step of generating a build log of the build of the software program.

4. The method according to claim 1 also comprising, upon completion of the build of the software program, notifying at least one user installation of the completed software program build.

5. The method according to claim 4, further comprising the step of preparing a build distribution list, prior to performing the step of notifying, comprising interested parties wishing to be notified of the completion of the software program build and using the list during the step of notifying.

6. A method of automatically performing a resource upgrade on a computer system coupled to a central distribution source, comprising:
automatically deploying an install package designated for a computer system destination from the central distribution source based on a request of such an install package;
automatically copying the install package on the computer system without user intervention;
automatically copying an install program associated with the install package on the computer system; and
automatically installing the resource upgrade on the computer system using the install program and contents within the install package.

7. The method according to claim 6 also comprising enabling an install controller located on the computer system prior to the installing step.

8. The method according to claim 6 further comprising the step of authorizing the installation of the resource upgrade by the install controller.

9. The method according to claim 6 also comprising the step of determining, prior to deploying the install package, whether the computer system is configured for having the resource upgrade installed thereon.

10. The method according to claim 6 wherein the installing step comprises obtaining any install values specific to the computer system.

11. The method according to claim 10 wherein the installing step also comprises:
ending any existing relevant server processes currently executing on the computer system prior to installing the resource upgrade thereon;
unpacking contents of the install package;
installing contents in locations specified in the install values;
performing the resource upgrade installation; and
restarting the server processes to resume operation of the computer system.

12. A system for building a software program composed of a plurality of software components generated by a plurality of software developers, comprising:
a manifest builder to build a manifest based on software components submitted for inclusion in the software program;
a build initiator, coupled to the manifest builder, for automatically initiating building of the software program based on the manifest;
a program builder, coupled to the build initiator, to automatically perform the build of the software program with the plurality of software components and to independently verify that the build of the software program is successful; and
an installation package builder, coupled to the program builder, to build an installation package for at least one destination machine utilizing the verified software program build.

13. The system according to claim 12 wherein the manifest builder monitors the build manifest to determine when the manifest has been modified by a submitted software component to be included in the software program.

14. The system according to claim 12 wherein the program builder further generates a build log of the build of the software program.

15. The system according to claim 12 wherein the program builder, upon completion of the build of the software program, is configured to notify selected parties of the completed software program build.

16. The system according to claim 15 wherein the program builder is configured to prepare a build distribution list of interested parties wishing to be notified of the completion of the software program build.

17. A system for preparing and deploying software packages to be installed automatically on a destination computer system via a computer link, comprising:
an installation package builder that is utilized to build an installation package for at least one destination machine incorporating a software program to be installed on a destination computer system;
an install package deployer integrated with the installation package builder and configured to deploy the installation package to the destination computer and install the installation package thereon;
an install program copier, coupled to the install package deployer, to copy the software program on the computer system; and
a software program installer, coupled to the install program copier, to install the software program on the computer system.

18. The system according to claim 17 further comprising an install controller located on the computer system to control the installation of the software program on the computer system.

19. The system according to claim 17 wherein the computer system includes software to determine whether the computer system is configured to have the software program installed thereon.

20. The system according to claim 17 wherein the software program installer is configured to obtain any install values specific to the computer system.

21. The system according to claim 20 wherein the software program installer is further configured to end any existing relevant server processes currently executing on the computer system prior to installing at least one resource upgrade thereon, unpack contents of the installation package, install contents in the installation program in locations specified in the install values; perform the software program installation, and restart the server processes to resume operation of the computer system.

22. The system according to claim 17 wherein the software program comprises resource upgrades for the computer system.

23. The system according to claim 17 wherein the software program comprises a program upgrade for a software program already resident on the computer system.

24. A computer system for preparing and deploying software packages to be installed automatically on a destination computer system via a computer link, comprising:
means for generating an installation package for at least one destination machine incorporating a software program to be installed on a destination computer system;
means for deploying the installation package to the destination computer; and
means for installing the installation package on the destination computer, which then proceeds to copy the software program on the computer system and install the software program on the computer system.

25. A computer system for building a software program composed of a plurality of software components generated by a plurality of software developers, comprising:
means for generating a manifest based on software components submitted for inclusion in the software program;
means for automatically initiating building of the software program based on the manifest;
means for building the software program with the plurality of software components and to independently verify that the build of the software program is successful; and
means for preparing an installation package for at least one destination machine utilizing the verified build of the software program.
